(19) United States
(12) Patent Application Publication
(10) Pub. No.: US 2021/0307984 A1
(43) Pub. Date: Oct. 7, 2021

(54) Mobile Screening and Utility Unit (MSUU)

(71) Applicant: Ronnie Akers, Columbus, GA (US)

(72) Inventor: Ronnie Akers, Columbus, GA (US)

(21) Appl. No.: 16/919,387

(22) Filed: Jul. 2, 2020

Related U.S. Application Data
(60) Provisional application No. 63/005,973, filed on Apr. 6, 2020.

(51) Int. Cl. A61G 10/00

(52) U.S. Cl. CPC A61G 10/005

(57) ABSTRACT

The Mobile Screening and Utility Unit (MSUU) serves as an additional, exposure-reducing, enclosed barrier for screeners. The MSUU reduces contracting any virus such as COVID-19 by person-to-person contact or aerosol means from symptomatic or asymptomatic patients while the screener is inside the unit. Key features are: reusable, wheel-based (used in/outside), and sanitized/disinfected using methods endorsed by the Centers for Disease Control and Prevention (thus reducing the need for expensive PPE). The unit front has a clear/transparent pane for visual acuity and two protective sleeves and pouch. The screener enters the unit from the rear, zips it shut, then moves forward to insert his or her arms through the sleeves and look through the pane. Screening is performed with minimal to no exposure to the screener. The screener can easily communicate without the use of additional audio equipment. Seated configurations are available that can be used with or without tables.

### BACKGROUND

The primary purpose of the MSUU is for individuals to use during screening of patients. Personal Protective Equipment (PPE) shortages during this current COVID-19 pandemic continues to be an issue. The U.S. was unprepared and over-whelmed for this because it had been making fewer masks, gowns and gloves domestically, and instead relying on importing those items from other countries. But since the COVID-19 outbreak began in Wuhan and China manufactures roughly 50% of masks and respirators around the world, the country needed masks at home first. Additionally, many of the workers who staffed PPE factories in China could not go to their jobs during the outbreak. As the virus spread around the world and demand for PPE ramped up, China was both exporting fewer masks and making fewer masks, which intensified the shortage. The stories are endless regarding health care workers reusing non-reusable PPE, developing make-shift, inadequate PPE, and ultimately, not being able to do their jobs because of no PPE. As a result, many people could not be screened timely; medical personnel were exposed to the COVID-19. Sadly, many people (including health care workers) succumbed to the viruses devastating effects.

### BRIEF SUMMARY OF THE INVENTION

The MSUU is a reusable shelter that serves as a barrier to prevent contracting viruses via airborne, aerosol means or person-to-person contact when screening people, servicing patients or entering environments with potential threats. It can be used either indoors or outdoors. One person can simply enter the unit from the rear and zip it shut (or leave it open for additional air flow), move forward and insert his or her arms through the available sleeves in the front and look through the transparent pane for visual acuity. This allows for screening with minimal to no exposure to the medical treatment employee or screener. The individual inside the unit can easily speak with the person being screened on the outside without the use of additional audio equipment. One person (either inside or outside) can carefully maneuver the unit since it is wheel-based and lightweight. The MSUU can be thoroughly sanitized or disinfected on an as needed basis using methods endorsed by the Centers for Disease Control and Prevention for surface cleaning. Since the MSUU can be disinfected and reused, it reduces the burn-rate and need for expensive PPE in some areas. Other potential uses for the MSUU can include transporting an ill patient, as a booth where reduced, protected, but necessary contact with the public is needed, and completely sealed/air tight from base to top for use in areas that may require such a capability. For ease of use, the MSUU can be disassembled or partially disassembled for storage and transportation purposes.

### BRIEF DESCRIPTION OF DRAWINGS

FIG. 1 shows the MSUU front outside view with barrier, roof, and wheelbase.

FIG. 1A shows the acuity pane

FIG. 1B shows the left arm protective sleeve

FIG. 1C shows the front storage utility pouch

FIG. 1D shows the right arm protective sleeve

FIG. 1E shows a person inside the MSUU with arms through protective sleeves

FIG. 2 shows the MSUU rear outside view with barrier, roof, and wheelbase

FIG. 2A shows the zipped entry and exit point for a person

FIG. 3 shows the MSUU right outside view with barrier, roof, and wheelbase

FIG. 3A shows the MSUU being sanitized or disinfected using CDC suggested solutions

FIG. 4 shows the MSUU left outside view with barrier, roof, and wheelbase

FIG. 4A shows the MSUU approximate width and height which can fit through most building doors

FIG. 5 shows the MSUU internal frame with wheelbase

FIG. 5A shows rear pole connecting bar

FIG. 5B shows upright supporting poles

FIG. 5C shows left side pole connecting bars

FIG. 5D shows front connecting pole bar

FIG. 5E shows right side connecting bars

FIG. 6 shows the MSUU removable roof with barrier protection

FIG. 6A shows 1-inch×1 inch×32-inch L lumber topside centered

FIG. 6B shows pole inserting endcaps underside

FIG. 7 shows the MSUU wheelbase top view

FIG. 7A shows pole inserting endcaps

FIG. 7B shows corner braces

FIG. 7C shows mending plates

FIG. 8 shows the MSUU wheelbase bottom view

FIG. 8A shows the General Duty Swivel Casters (wheels)

FIG. 9 shows the MSUU seated configuration installed work bench

FIG. 9A shows the acuity pane

FIG. 9B a person seated inside the MSUU behind the protective barrier

FIG. 9C shows the right arm protective sleeve

FIG. 9D shows the left arm protective sleeve

FIG. 9E shows the installed work bench

FIG. 10 shows the MSUU seated configuration without a work bench

FIG. 10A shows the acuity pane

FIG. 10B a person seated inside the MSUU behind the protective barrier

FIG. 10C shows the right arm protective sleeve

FIG. 10D shows the left arm protective sleeve

FIG. 10E shows the MSUU seated configuration around a table

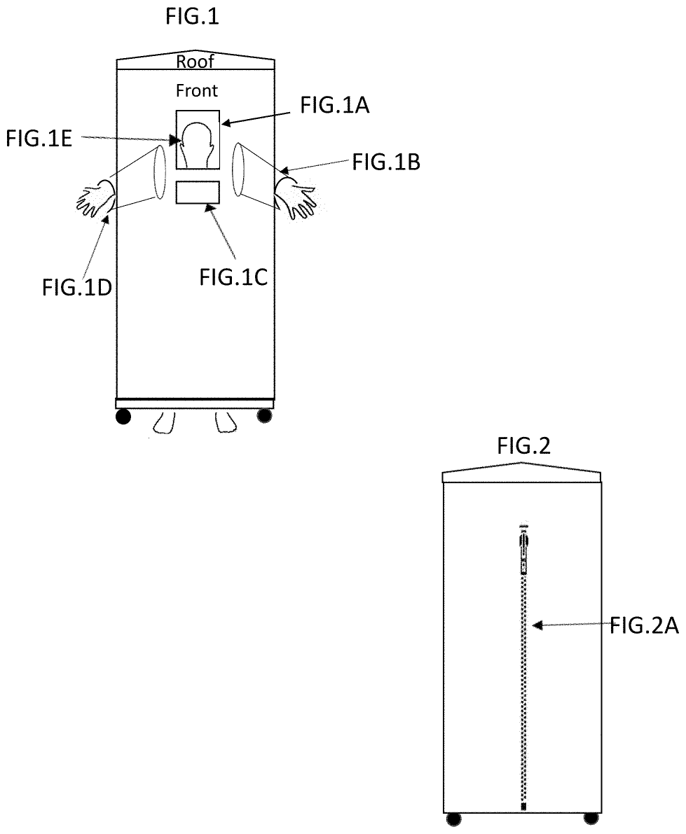

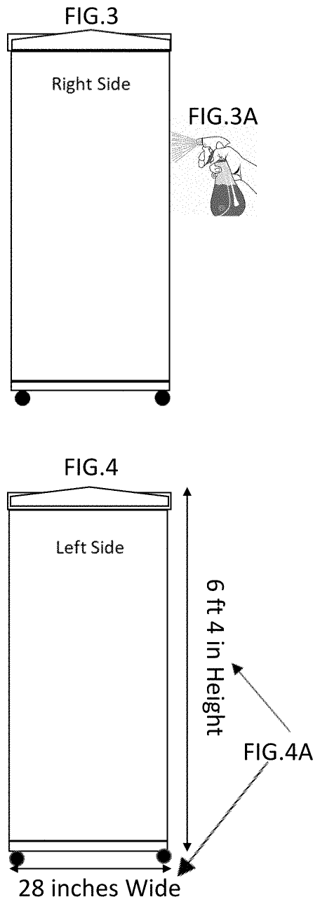

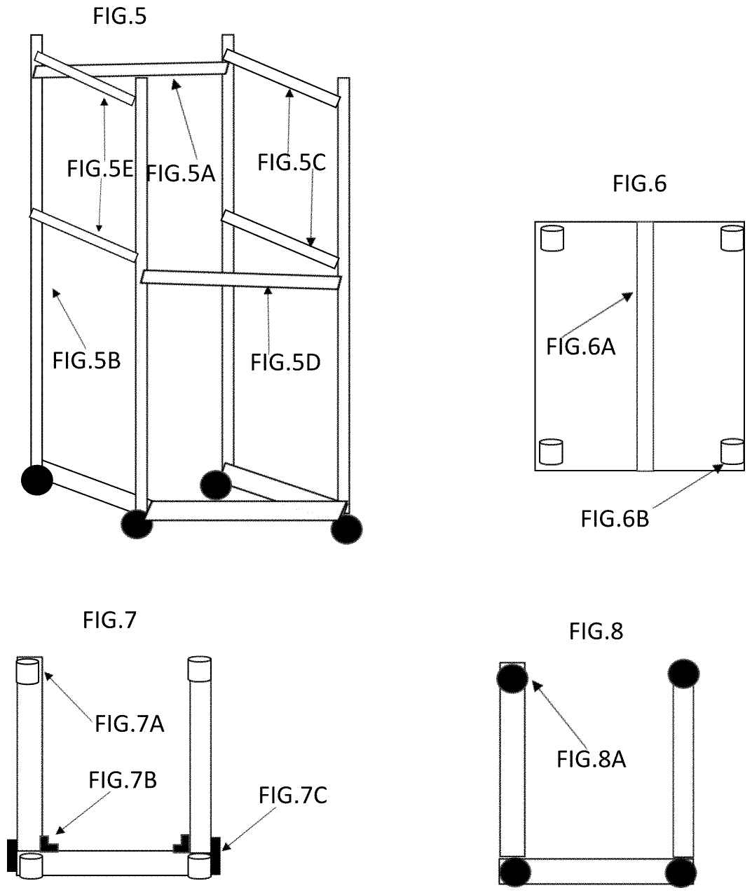

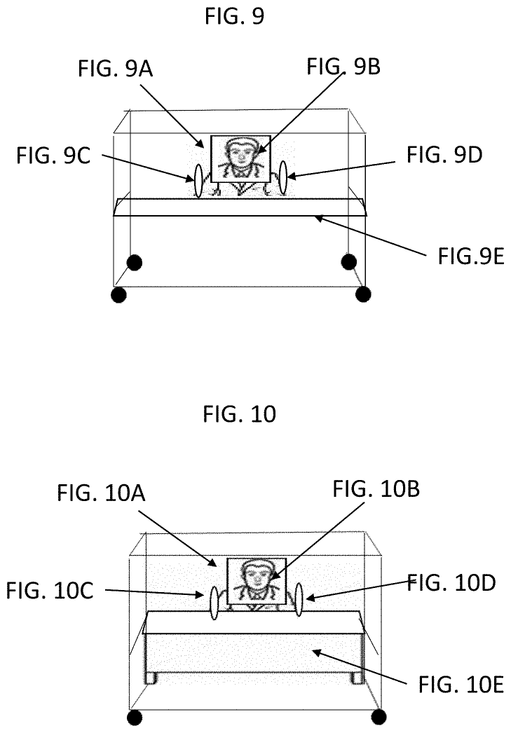

### DETAILED DESCRIPTION OF THE INVENTION

Details of the invention are outlined below. In describing the invention some terminology is used for the sake of clarity. However, the invention is not intended to be limited in scope. Anyone who is technically competent in manufacturing understands that other components, configurations, designs, and protective barrier materials can be used without parting from the spirit and scope of the invention. During pandemics, there has historically been a higher than expected demand for Personal Protective Equipment (PPE). Health care workers (out of need) began reusing disposable PPE (creating significant health risks). In some cases, testing is not performed because the appropriate PPE is not available. Here, the MSUU can be used to drastically reduce the need for PPE and consequently the risk of contamination. The MSUU design is an enclosed, rectangular shaped booth that an individual can stand inside (there is no floor) to conduct screening. The current protective barrier material used is a continuous sheet of polyethylene (Tarpaulin or Tarp approximately 10 ft height×16 ft in Length). The front side of the unit has an 8 inch×10 inch framed glass (or 0.220 thickness clear acrylic) acuity pane (centered 8 inches below the top of the tarp) and a covered sleeve insert on each side of the acuity pane. An area 7½ in×9½ is outlined on the tarp then cut out with a razor or other cutting means commonly known in the art or manufacturing. The pane is then inserted back in the frame and the frame is Velcro taped on the outside tarp. The sleeves are 26 inches in length and can be constructed using the tarp excess. A 26-inch slit (12 inches from the tarp top and approximately 4 inches on each side of the pane frame) is cut in the tarp. The sleeves are pushed through the slits and the shoulder end is connected on the inside of the tarp using Velcro tape. The sleeves are tapered ranging from a girth of 26 inches at the end connected to the unit (the shoulder area), to a 15-inch girth at the wrist opening. The sleeves have a Velcro strip at the “wrist” end to ensure a snug fit around it. The utility pouch underneath the pane frame is 12 in L×5 in W×7 in Height. It is Velcro taped to the outside of the tarp. The rear side of the unit is used for entry and exit. A sticky back zipper (or other means for sealing the opening commonly known in the art or medical sealing 62 inches in length) is centered and applied to the back area five inches below the top of the tarp. The left and right tarp sides of the unit are not altered (note that the alterations to the tarp can only occur after the tarp is attached to the frame). The frame is designed using the following material:
The “U” shaped wheelbase is designed using three wood boards 1 ‘in″ thick×3 inch W×28 in L. Two boards are placed vertically on each end of a parallel board giving the wheelbase its 32 in Length×28 in width. The boards are held together with 1½ in corner braces on the two inside corners. Additionally, the boards are connected using 3-inch mending plates (centered) on each side where the boards adjoin. On the wheelbase bottom, a wheel (four each Caster Rubber Swivel) is attached at each corner using four each 1½-inch machine screws and flat washers on each wheel.
Four 6 ft height PVC upright supporting poles (heavy duty or HD) 1 in diameter; one on each corner of the wheelbase inside the mounted base endcaps. The endcaps (1¼ in diameter) are attached to the wheelbase using ¾ in wood screws bore through its center.
Four 32 in″ side connecting bars PVC (HD 1 in in diameter; two on each side). The bars are placed 3 in and 30 in below the top and on the inside of the front and rear pole using a 1½ in machine screw at each end to connect to the poles. This applies to both sides.
One 28 in front connecting bar PVC (HD 1 in diameter). The bar is placed 43 in below the top and on the inside of the front poles using a 1½ in machine screw at each end to connect to the poles.
One 28 in rear connecting bar PVC (HD 1 in′ in diameter) The bar is placed 4½ in below the top and on the inside of the rear poles using a 1½ in machine screw at each end to connect to the poles.
The frame is erected when the wheelbase is complete, supporting poles properly inserted in base endcaps, and the connecting bars are attached to supporting poles. A ¾ inch 70 in L Sticky Back Velcro Strip is placed 1¾ inch below the top of each supporting pole downward along the outside area of each pole. Starting at either rear pole, the tarp is securely fastened to each supporting pole. When the initial starting pole is reached, a Velcro strip is applied to the outside area of the tarp. The final section of the tarp is attached to the Velcro strip. The unit is completely enclosed. The front and rear tarp sections can now be configured IAW the stated design specifications. The rear area should be configured first then the front area.
The roof (or top), 32-inch Length×28-inch width, is made with ⅛ in thick tempered wood. An end cap (1¼-inch diameter) is attached on each corner of the roof using ¾ in wood screws bore through its center from the top of the roof downward. A 1 inch by 1-inch×32-inch L lumber wood is centered and glued on the top side of the roof for pitch. The roof is then covered with the tarp; secured using heavy duty staples. The roof has a 5-inch tarp drape on three sides. The back of the roof has a 2-inch drape. This allows for ventilation inside the unit. The roof is removable. From a utility aspect, the MSUU can be modified to fit around three sides of a rectangular or square table or designed to include an installed work bench. Since the seated configuration has more frontage, multiple acuity panes and sleeve ports can be added.

The following claims are made:

1. An apparatus comprising: a five-sided rectangle structure standing in the length wise direction with wheels on the bottom comprising:
the structure including a protective barrier on all sides and the top,
the structure including wheels on the bottom for mobility,
the structure including a window on the front barrier sealed within the structure,
the structure including a sealed entrance on the back,

2. The apparatus of claim 1 wherein the window is made of glass, plexiglass, acrylic, or any suitable see-through material.

3. The apparatus of claim 1 wherein a utility pouch is situated on outside front below the window.

4. The apparatus of claim 1 wherein barrier material is made of polyethylene.

5. The apparatus of claim 1 wherein the rear entrance is a zipper or plastic zip or other means of entering and sealing.

6. The apparatus of claim 5 wherein the rear entrance is a door.

7. The apparatus of claim 5 wherein the rear entrance is a slit centered then sealed with a zipper.

8. The apparatus of claim 1 wherein the structure is configurable to use while seated.

9. The apparatus of claim 8 wherein the structure includes an installed work bench.

10. The apparatus of claim 8 wherein the structure fits around a six- or eight-foot table.

11. A method comprising: making a rectangular structure between 6 and 8 feet tall,
covering the structure with a protective material on all sides but the bottom,
placing a sealed window on the front side of the structure,
placing a sealed entrance on the backside of the structure, placing wheels on the bottom of the structure.

12. The method claim 11 wherein a utility pouch is placed outside and underneath the front window or pane.

13. The method of claim 11 wherein the window or pane is made of glass, plexiglass, acrylic, or any suitable see-through material.

14. The method of claim 11 wherein the rear entrance is made of a zipper or plastic zip or other means of entering and sealing.

15. The process comprising: one or more person entering the backside of a four sided rectangle with a roof all made of protective material that is sealed at all seams, the occupant enters the rear of the structure and closes the structure, the occupant then places their arms inside two long sleeves that are sealed to the structure,

16. The process of claim 11 allowing the occupant to seal the sleeves around the wrist,

17. The process of claim 11 allowing the occupant to communicate without the use of additional audio equipment.

18. A process of claim 1 wherein the material can be sanitized or disinfected using regular cleaning solutions.

19. The apparatus of claim 1 wherein the structure can be disassembled or partially disassembled for storage and transportation purposes.
